(19) United States
(12) Patent Application Publication
(10) Pub. No.: US 2020/0139998 A1
(43) Pub. Date: May 7, 2020

(54) Shopping Cart Gate with Fixed Child Seat

(71) Applicant: Unarco Industries LLC, Wagoner, OK (US)

(72) Inventor: William Timothy Harrison, Muskogee, OK (US)

(21) Appl. No.: 16/676,992

(22) Filed: Nov. 7, 2019

Related U.S. Application Data
(60) Provisional application No. 62/756,947, filed on Nov. 7, 2018.

(51) Int. Cl. B62B 5/08; A47F 13/00; A47D 1/10; B62B 3/18; B62B 5/00

(52) U.S. Cl. CPC B62B 5/082; A47F 13/00; B62B 5/0013; B62B 3/18; A47D 1/10

(57) ABSTRACT

A rear gate for a shopping cart where a child seat is attached to the rear gate such that the child seat does not move relative to the rear gate. The child seat is fixed to the rear gate, but the rear gate is pivotally attached to the frame of the shopping cart to allow the shopping carts to be nested together.

### RELATED APPLICATION DATA

This application claims the benefit U.S. Provisional Patent Application No. 62/756,947, filed on Nov. 7, 2018, which is hereby incorporated by reference in its entirety.

### FIELD OF THE INVENTION

This disclosure relates to a shopping cart for use in stores with a fixed child seat attached to the rear gate of the shopping cart.

### BACKGROUND

The typical shopping cart is constructed with a frame, a plurality casters attached to the frame, a basket, a hinged rear gate and a child seat. The child seat typically folds against the rear gate when not in use or extends forward from the rear gate when needed for use. The typical rear gate assembly on a shopping cart that includes a child seat assembly that is comprised of three attached components, all of which move independently of each other. The three components are an outer portion, a seat section, and an inner portion. The independent movement of each of the three components allows the child seat assembly to extend and retract during the opening and closing of the inner portion thereby providing an enclosed flat area to either store items or rest a child with a seatbelt.

The moving parts described above typically cause some degree of noise due to rattling when the cart is in motion. In addition, the movement of the components as they pivot during the numerous extension and retraction cycles create wear spots in the contact areas that can deteriorate the coating in those areas. As the coating deteriorates, these regions may exhibit rust which may create a negative impression with a consumer and shorten the life cycle of the shopping cart. A child seat that eliminates these wear spots and reduces the noise from the cart while still providing an effective child seat would be welcome.

### SUMMARY

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to one aspect, a shopping cart is disclosed. In some examples, the shopping cart may include a frame, a plurality of casters attached underneath the frame, a handle attached to a rear portion of the frame, a basket positioned above the frame, and a rear gate assembly pivotally attached to the frame. In other examples, the rear gate assembly may include a rear gate and a child seat. In other examples, the child seat may be fixed to the rear gate such that is does not move relative to the rear gate. In still other examples, the child seat may include a lower seat portion and a back portion, where the base of the lower seat portion and the base of the back portion may include a rim wire and a brace loop wire. In still other examples, the rim wire and the brace loop wire may be attached to the rear gate, where the rim wire may have connection points with the rear gate above the connection points where the brace loop attaches to the rear gate. In other examples, the child seat may further include a support wire that may be connected to the rear gate at a position above the location of the connection points of the rim wire with the rear gate and the connection points of the brace loop wire.

In some examples, the child seat may also include a seat cover. In other examples, the lower seat portion and the back portion may further include a plurality of wire loops, and the plurality of wire loops may be permanently attached to portions of the rim wire and portions of the brace loop wire. In yet other examples, the plurality of wire loops may extend forward from a location near the rear gate, and the plurality of wire loops may be configured with a bend extending upward from a rear of the lower seat portion. In still other examples, the plurality of wire loops may extend forward from a location near the rear gate, and the plurality of wire loops may be configured with a bend extending upward from a rear of the lower seat portion.

In other examples, the lower seat portion may also include a plurality of horizontal wires, and the plurality of horizontal wires may be spaced evenly across the plurality of wire loops, the brace loop wire, and the rim wire. In some examples, the plurality of horizontal wires may extend horizontally across the wire loops, the brace loop wire, and the rim wire at generally a right angle to form a wire mesh. In other examples, the lower seat portion may include at least four horizontal wires. In still other examples, handle may extend from the frame forming an angle relative to the back portion, and the angle formed may be about 5 degrees to about 15 degrees. In another example, the rear gate assembly may be pivotally attached to the frame, and wherein the shopping cart is configured to nest with a second shopping cart. In other examples, when viewed from the side, an angle formed between the lower seat portion and the back portion may be about 93 degrees to about 105 degrees.

According to another aspect, a method of forming a shopping cart is disclosed. In one example, the method may include forming a frame and forming a basket in which the basket may be configured to engage the frame and the basket may be positioned above the frame. In some examples, the method may also include forming a rear gate assembly in which the rear gate assembly may be pivotally attached to the frame, and forming a child seat in which the child seat may comprise a lower seat portion and a back portion. In other examples, the child seat may be formed in such a manner that it is fixed to the rear gate assembly and the child seat may not move relative to the rear gate assembly.

In some examples, the child seat may also include a plurality of wires. In other examples, the plurality of wires may be formed as a substantially flat wire mat. In yet other examples, the flat wire mat may be bent to form the lower seat portion and the back portion. In another example, the plurality of wires may form a wire mesh. In other examples, the flat wire mat may bent to form an angle between the lower seat portion and the back portion. In other examples, the angle may be about 93 degrees to about 105 degrees.

According to sill another aspect, a child seat for a shopping cart is disclosed. In certain examples, the child seat may include a lower seat portion and a back portion. In other examples, the base of the lower seat portion and the base of the back portion may include a rim wire and a brace loop wire. In some examples, the rim wire and the brace loop wire may be attached to the rear gate of a shopping cart. In yet other examples, the rear gate of the shopping cart may be configured to pivotally engage a frame of the shopping cart. In still other examples, the child seat may be fixed in a manner as to not move relative to the rear gate.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and not limited in the accompanying figures in which like reference numerals indicate similar elements and in which:

FIG. 1 is a front top perspective view of a rear gate of a shopping cart with a fixed child seat as disclosed herein;

FIG. 2 is a front top perspective view of a shopping cart that has the rear gate with a fixed child seat of FIG. 1 as disclosed herein;

FIG. 3 is a side perspective view of a shopping cart that has the rear gate with a fixed child seat of FIG. 1 as disclosed herein;

FIG. 4 is a partial top perspective view of a shopping cart that has the rear gate with a fixed child seat of FIG. 1 as disclosed herein;

FIG. 5 is a partial rear side perspective view of a shopping cart that has the rear gate with a fixed child seat of FIG. 1 as disclosed herein;

FIG. 6 is a partial rear top perspective view of a shopping cart that has the rear gate with a fixed child seat of FIG. 1 as disclosed herein;

FIG. 7 is a front view of the rear gate with a fixed child seat of FIG. 1 as disclosed herein;

FIG. 8 is a side view of the rear gate with a fixed child seat of FIG. 7 as disclosed herein;

FIG. 9 is a detailed view of the rear gate with a fixed child seat of FIG. 8 as disclosed herein;

FIG. 10 is a rear perspective view of detailed view of the child seat of FIG. 1 with the rear gate removed for clarity as disclosed herein;

FIG. 11 is a side view of a plurality of shopping carts having the rear gate with the fixed child seat of FIG. 1 that are nested together as disclosed herein;

FIG. 12 is a front view of the child seat in a substantially flattened state during its fabrication process; and

FIG. 13 a side view of the child seat in a substantially flattened state of FIG. 12.

Further, it is to be understood that the drawings may represent the scale of different components of one single embodiment; however, the disclosed embodiments are not limited to that particular scale.

### DETAILED DESCRIPTION OF EMBODIMENTS

In the following description of various example structures according to the invention, reference is made to the accompanying drawings, which form a part hereof, and in which are shown by way of illustration various example devices, systems, and environments in which aspects of the invention may be practiced. It is to be understood that other specific arrangements of parts, example devices, systems, and environments may be utilized and structural and functional modifications may be made without departing from the scope of the present invention.

Also, while the terms “top,” “bottom,” “front,” “back,” “side,” “rear,” and the like may be used in this specification to describe various example features and elements of the invention, these terms are used herein as a matter of convenience, e.g., based on the example orientations shown in the figures or the orientation during typical use. Nothing in this specification should be construed as requiring a specific three dimensional orientation of structures in order to fall within the scope of this invention. The reader is advised that the attached drawings are not necessarily drawn to scale.

Generally, this disclosure relates to a shopping cart 10 with a rear gate assembly 100 having a child seat 120 that is fixed to the rear gate 110. The child seat 120 has a wire structure that is fixed to the rear gate so the child seat 120 does not move relative to rear gate 110. The fixed child seat 120 may reduce the noise of the cart 10 while eliminating the wear at the contact points. In general, the rear gate 110, the child seat 120, and the basket 14 of the shopping cart 10 may be fabricated from a plurality of wires that are formed and permanently joined together to create a variety of wire meshes that make up these components. The wires may be permanently joined together through a welding process or other similar process.

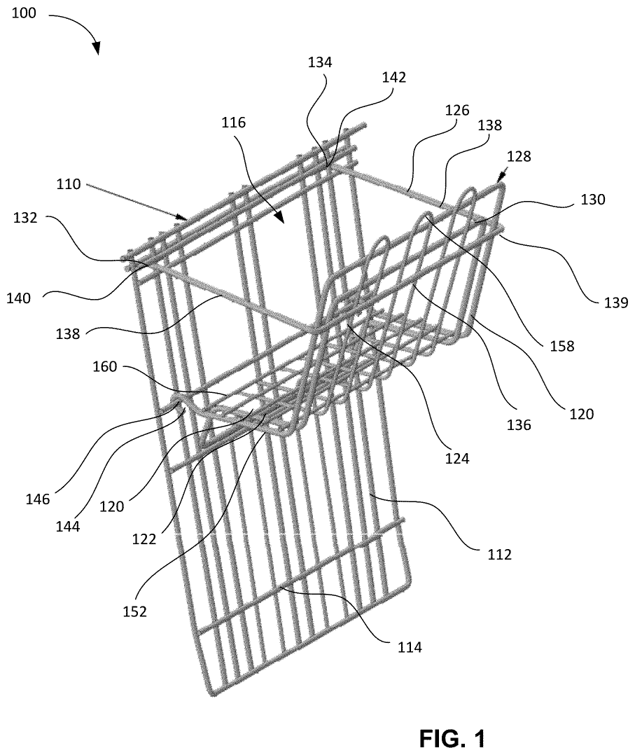

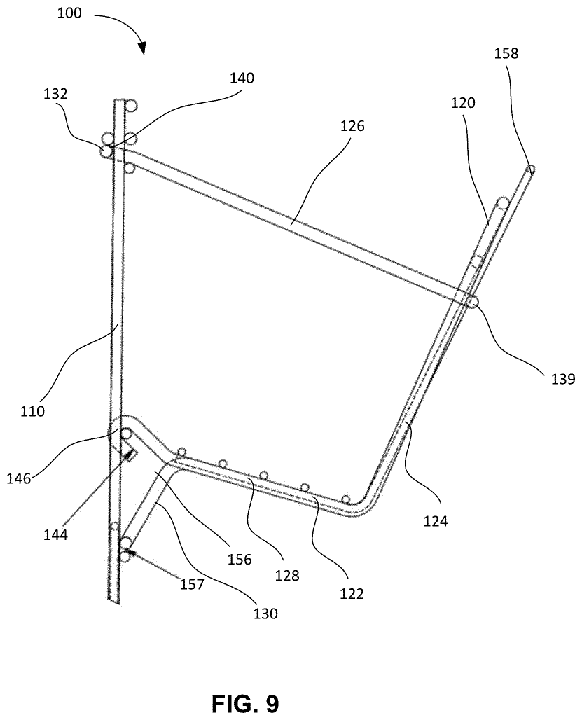

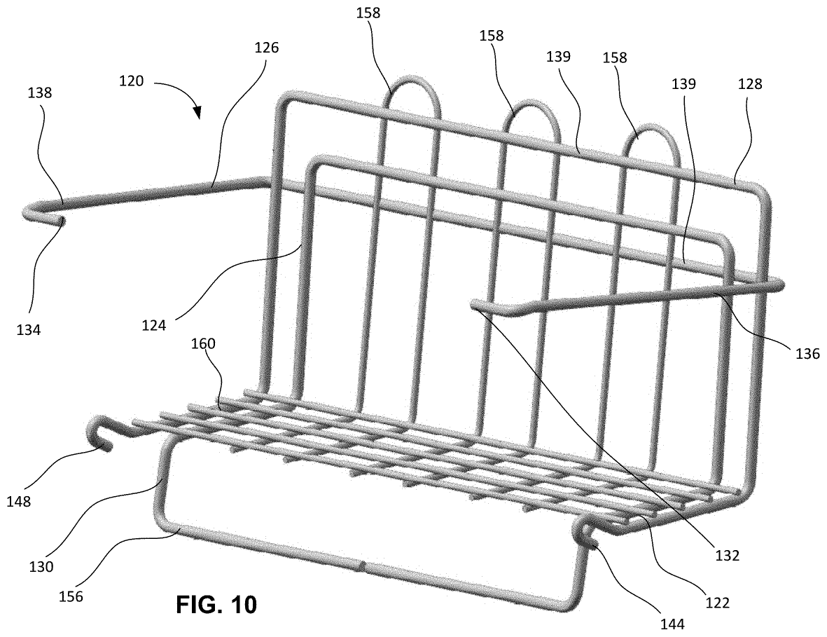

FIGS. 1 and 7-9 illustrate a rear gate assembly 100 while FIG. 10 illustrates a child seat 120 with the rear gate 110 removed for clarity. The rear gate assembly 100 may include a rear gate 110 and a child seat 120 where the child seat comprises a lower seat portion 122, and a back portion 124, where the lower seat portion 122 and back portion 124 may include a support wire 126, a rim wire 128, and a brace loop wire 130. The child seat 120 may extend across the majority of the rear gate 110, and may have a length that extends approximately 90 percent of the length of the rear gate or between 80 percent and 95 percent of the length of the rear gate. The rear gate assembly 100 may also be arranged in a symmetrical manner such that both the rear gate 110 and child seat 120 are symmetrical about a center plane of the cart 10 that extends forward from a midpoint of the handle 20 and extends vertically upward from a bottom of the cart 10 to the top of the cart 10.

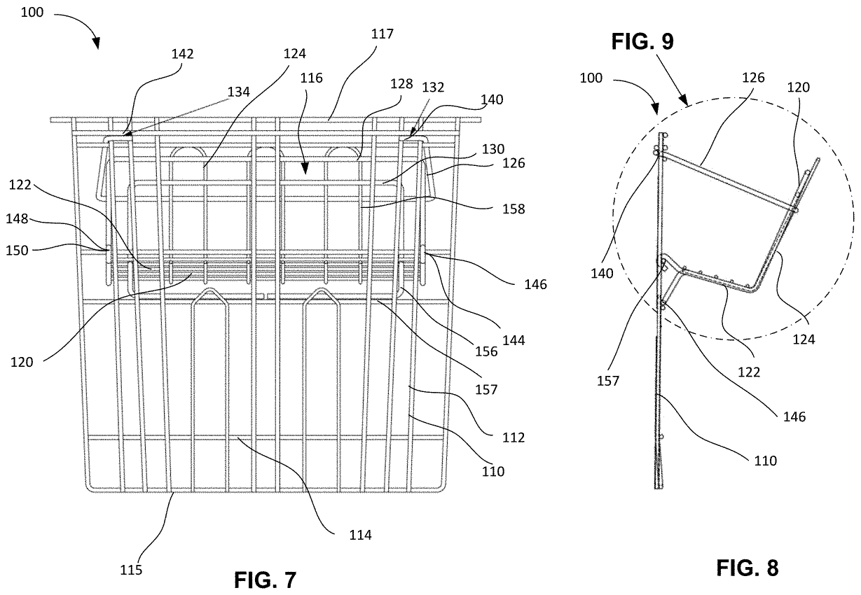

The rear gate 110 may comprise a plurality of substantially vertical oriented wires 112 joined to a plurality of substantially horizontal wires 114. Some of the vertical wires extend the full length of the rear gate 110, while others extend only a portion of the length of the rear gate 110 to allow for openings 116 to receive a child's legs when they are sitting in the child seat 120. Additionally, the plurality of vertical wires 112 may generally be spaced apart from one another and extend outward as they move from the bottom 115 of the rear gate 110 to the top 117 of the rear gate 110 as shown in FIG. 7.

The support wire 126 may have a first end 132 connected to the rear gate 110 at the first upper connection point 140, a second end 134 connected to the rear gate 110 at the second upper connection point 142, and a central member 136 extending between the first end 132 and the second end 134. The central member 136 may include retaining portions 138 that extend forward from the rear gate 110 away from the connection points 140, 142 toward the back portion 124, and a central portion 139 that may extend horizontally across the rear of the back portion 124. This support wire 126 may help to hold the child seat 120 at the proper distance from the rear gate 110. In addition, the support wire 126 is attached to the rear gate 110 at both sides of the child seat and define the outer extents of the child seat 120. In addition, the support wire 126 may provide support on the sides to help retain a child within the seat.

The rim wire 128 may comprise a first end 144 attached to the rear gate 110 at the first lower connection point 146 and a second end 148 attached at second lower connection point 150. Generally, the base 152 of the lower seat portion 122 and the base 154 of the back portion 124 may be partially formed by the rim wire 128. For example, the rim wire 128 may extend forward from the connection points 146, 150 to form side edges of the base 152 of the lower seat portion 122 and bend upward from the rear of the lower seat portion 122 to form side edges of the base 154 of the back portion 124 and then extend horizontally across the back portion 124 to form an upper side edge of the base 154. The upper connection points 140, 142 of the support wire 126 may be positioned above the lower connection points 146, 150 of the rim wire 128 on the rear gate 110.

In addition, a brace loop wire 130 may also form a portion of the base 152 of the lower seat portion 122 and the base 154 of the back portion 124. The brace loop wire 130 may be spaced inward from the rim wire 128 and generally follow the path of the rim wire 128 on the lower seat portion 122 and back portion 124. The brace loop wire 130 may further include a lower extension 156 that extends from base 152 of the lower seat portion 122 to the rear gate 110. The lower extension 156 angles downward and rearward from the lower seat portion 122 and then extends horizontally across the rear gate 110. The lower extension 156 may be permanently attached to the rear gate 110 at a connection point 157. For example, the lower extension 156 may be welded to a horizontal wire 114 of the rear gate 110. Further, the lower extension 156 may comprise the ends of the wire that are bent inward such that the ends leave a space between them. The rim wire 128 and the brace loop wire 130 combine to form the base 152 for the lower seat portion 122 and the base for the back portion 124, where the brace loop wire 130 is spaced inward from the rim wire 128. The upper connection points 140, 142 of the support wire 126 may be positioned above the lower connection points 146, 150 of the rim wire 128 and the connection point 157 of the brace loop wire 130 on the rear gate 110. The lower connection points 146, 150 of the rim wire 128 may be positioned above the connection point 157 of the brace loop wire 130 on the rear gate 110.

The seat base 152 forms a foundation for a plurality of wires loops 158 to be attached to rim wire 128 and the brace loop wire 130. The wire loops 158 may be permanently attached to the portions of the rim wire 128 and the brace loop wire 130 that extend across the back portion 124 of the child seat 120. The wire loops 158 may extend forward from a location near the rear gate 110 and then have a bend to extend upward from a rear of the lower seat portion 122. The wire loops 158 may also be evenly spaced apart to for a uniformly spaced wire mesh to form the lower seat portion 122 and back portion 124. Near the upper region of the back portion 124, the wire loops 158 may be positioned between the support wire 126 and the rim wire 128 and the brace loop wire 130. In other words, the wire loops 158 are connected to the forward side of the rim wire 128 and the brace loop wire 130 and the rear side of the support wire 126.

The lower seat portion 122 may further comprise a plurality of wires 160 spaced evenly across the wire loops 158, the brace loop wire 130, and the rim wire 128. The plurality of wires 160 generally extend horizontally across the wire loops 158, the brace loop wire 130, and the rim wire 128 at generally a right angle to form a wire mesh.

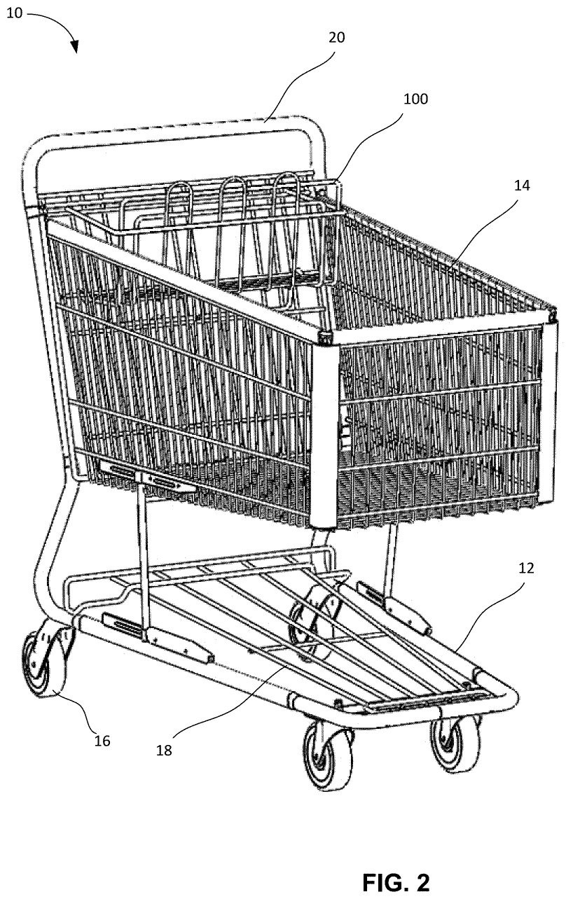

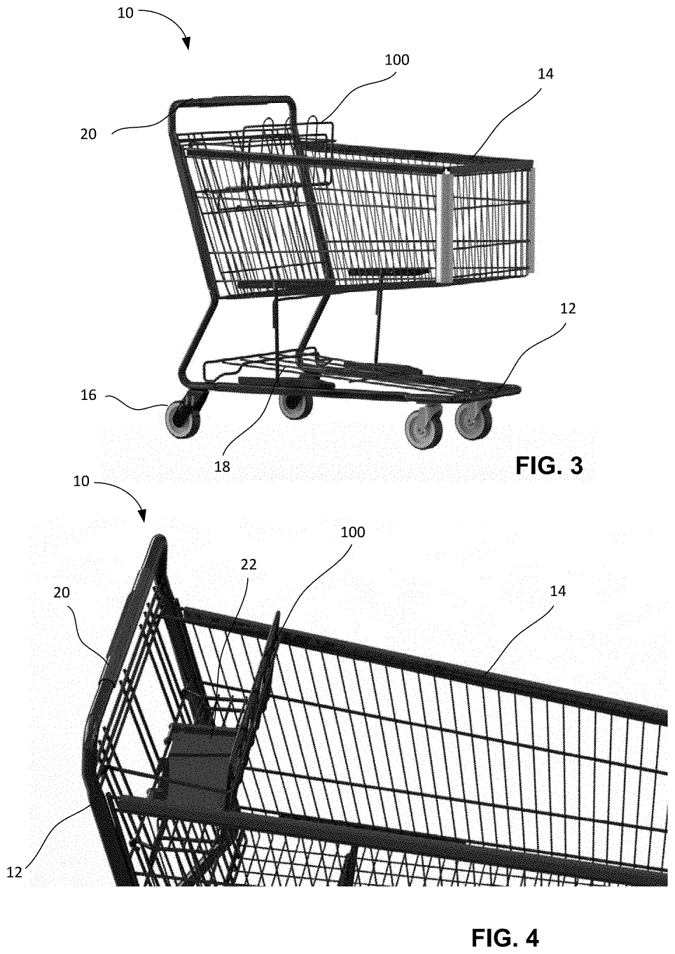

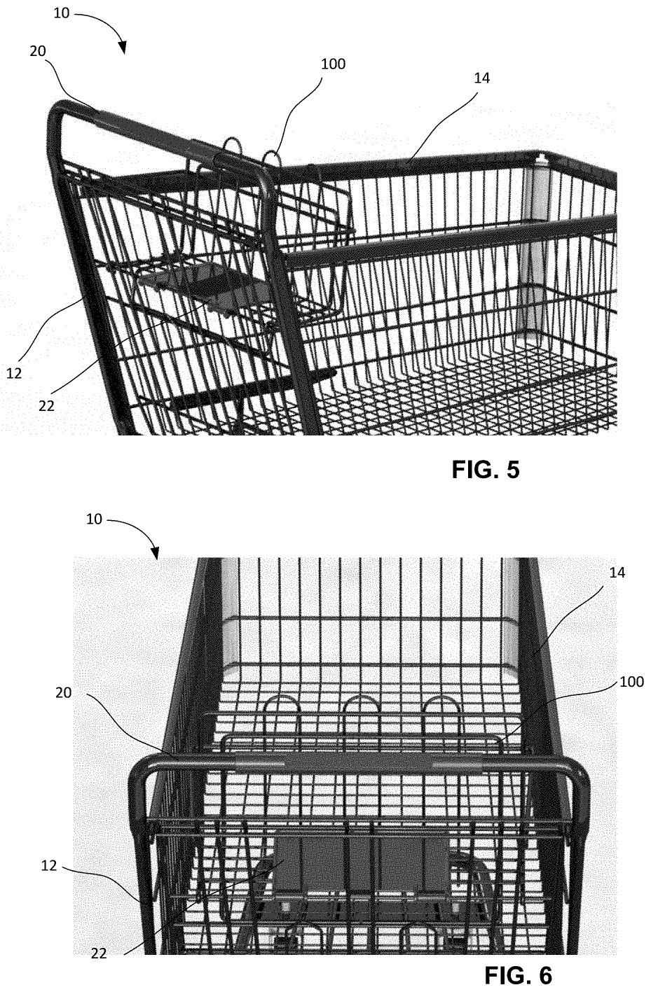

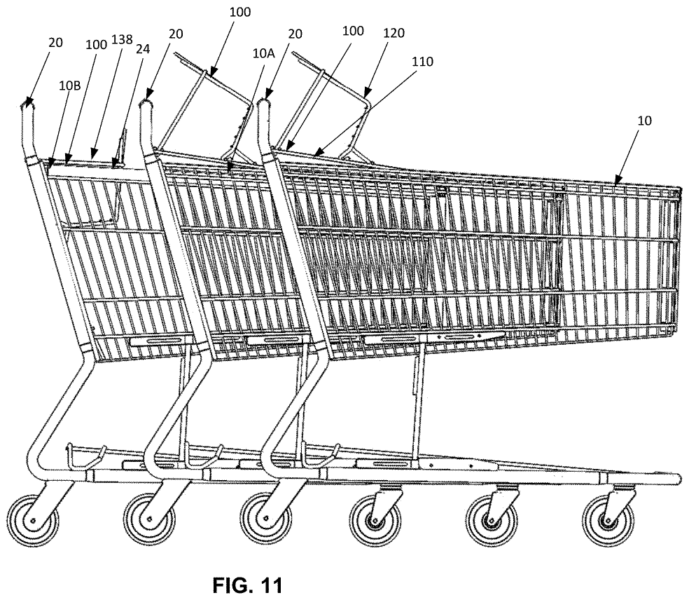

FIGS. 2-6 illustrate a shopping cart 10 with the rear gate assembly 100 installed. The shopping cart 10 may include a frame 12, a basket 14 supported by the frame 12, a plurality of casters 16 attached underneath the frame 12, a lower tray 18 located above a portion of the frame, a handle 20 attached to the frame 12 at the rear of the cart 10, and a rear gate assembly pivotally attached to the frame 12. In addition, the cart 10 may include a child seat cover 22 that pivotally rotates down to cover the wire mesh lower seat portion 122, or upward to cover the child seat leg holes. The child seat cover 22 is best illustrated in FIGS. 4-6. The frame 12 may form the lower portion of the cart 10 as well as extending upward at the rear of the cart 10 on both sides to support the handle 20. The handle 20 may extend substantially vertical from its attachment point at the junction of the frame 12 and the basket 14. In other words, the handle 20 may extend from the frame to form an obtuse angle with the rear portion of the frame that extend along the basket 14. In addition, the handle 20 may extend, when viewed from a side of the cart 10 as in FIG. 11, at an angle of approximately 10 degrees, or within a range of 5 and 15 degrees relative to the back portion 124 of the child seat 120.

The rear gate 110 may be pivotally attached to the frame 12 of the shopping cart 10 to allow the shopping carts 10 to nest with one another as shown in FIG. 11. When the carts 10 nest with each other, the forward portion of a rear cart 10A contacts the back of the rear gate 110 of a forward cart 10B and pushes the rear gate 110 of the forward cart 10B upwards. As the rear cart 10A pushes the rear gate 110 of the forward cart 10B, the rear gate 110, being pivotally attached to the frame, rotates about its connection point. The rear gate 110 along with its attached child seat 120 of the forward cart 10B rotate upwards to allow the rear cart 10A to nest into the forward cart 10B.

As shown in FIG. 7, the support wire 126 of the child seat 120 may have ends 132, 134 that extend through an opening between the horizontal wires 114 and vertical wires 112 and then bend outward to form a mechanical connection to secure the support wire 126 to the rear gate 110. In addition to or optionally, the ends 132, 134 may additionally be permanently attached using a permanent joining method such as welding, brazing, adhesive, or other known joining method. The retaining portions 138 of the support wire 126 may be oriented generally parallel to a top surface 24 of the basket 14 and spaced above the top surface 24 of the shopping cart 10 when the rear gate assembly 100 is in the usage position, i.e. the cart 10 is not nested with another cart.

As discussed above, the rim wire 128 may have ends 144, 148 that attached to the rear gate 110. The ends 144, 148 may form a hook shape that wraps around one of the plurality of horizontal wires 114 of the rear gate 110. The hook shape may be mechanically crimped around the wire 114 after installation to prevent any movement of the child seat 120 relative to the rear gate 110.

The child seat 120 may also have some specific dimensional aspects to provide a comfortable child seat. The lower seat portion 122 may form an obtuse angle of with the back portion 124. For example, the angle between the lower seat portion and the back portion may be approximately 98 degrees or within a range of 93 degrees and 105 degrees.

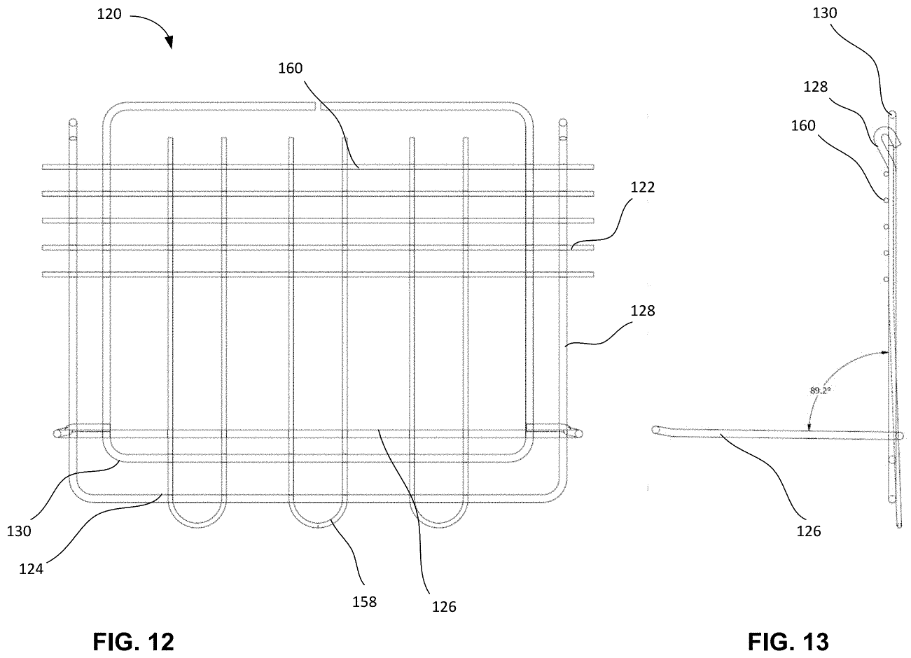

As previously discussed, the child seat 120 may be formed from a plurality of wires arranged and welded together at the junctures where they cross. The child seat 120 may be formed as a substantially flat wire mat that is then bent to the final shape. FIGS. 12 and 13 illustrate front and side views of the wire mat prior to bending. By forming the child seat 120 in a substantially flat orientation, the manufacturing is simpler and also allows for less storage space for the work in progress.

The present disclosure is disclosed above and in the accompanying drawings with reference to a variety of examples. The purpose served by the disclosure, however, is to provide examples of the various features and concepts related to the disclosure, not to limit the scope of the invention. One skilled in the relevant art will recognize that numerous variations and modifications may be made to the examples described above without departing from the scope of the present disclosure.

We claim:

1. A shopping cart comprising:
a frame;
a plurality of casters wherein the plurality of casters are attached underneath the frame;
a handle attached to a rear portion of the frame;
a basket positioned above the frame; and
a rear gate assembly pivotally attached to the frame,
wherein the rear gate assembly includes a rear gate and a child seat,
wherein the child seat is fixed to the rear gate assembly such that is does not move relative to the rear gate,
wherein the child seat comprises a lower seat portion and a back portion,
wherein the base of the lower seat portion and the base of the back portion include a rim wire and a brace loop wire,
wherein the rim wire and the brace loop wire are attached to the rear gate assembly,
wherein the rim wire has connection points with the rear gate assembly above the connection points where the brace loop attaches to the rear gate, and
wherein child seat further comprises a support wire wherein the support wire is connected to the rear gate at a position above a location of the connection points of the rim wire with the rear gate and the connection points of the brace loop wire.

2. The shopping cart of claim 1, wherein the child seat further includes a seat cover.

3. The shopping cart of claim 1, wherein the lower seat portion and the back portion further include a plurality of wire loops, wherein the plurality of wire loops are permanently attached to portions of the rim wire and portions of the brace loop wire.

4. The shopping cart of claim 3, wherein the plurality of wire loops extend forward from a location near the rear gate, and wherein the plurality of wire loops are configured with a bend extending upward from a rear of the lower seat portion.

5. The shopping cart of claim 3, wherein the lower seat portion further includes a plurality of horizontal wires, wherein the plurality of horizontal wires are spaced evenly across the plurality of wire loops, the brace loop wire, and the rim wire.

6. The shopping cart of claim 5, wherein the plurality of horizontal wires extends horizontally across the wire loops, the brace loop wire, and the rim wire at generally a right angle to form a wire mesh.

7. The shopping cart of claim 5, wherein the lower seat portion includes at least four horizontal wires.

8. The shopping cart of claim 1, wherein the handle extends from the frame forming an angle relative to the back portion, and wherein the angle formed is about 5 degrees to about 15 degrees.

9. The shopping cart of claim 1, wherein the rear gate assembly is pivotally attached to the frame, and wherein the shopping cart is configured to nest with a second shopping cart.

10. The shopping cart of claim 1, wherein an angle between the lower seat portion and the back portion is about 93 degrees to about 105 degrees.

11. A method of making a shopping cart comprising:
forming a frame;
forming a basket, wherein the basket is configured to engage the frame, and wherein the basket is positioned above the frame;
forming a rear gate assembly, wherein the rear gate assembly is pivotally attached to the frame; and
forming a child seat, wherein the child seat comprises a lower seat portion and a back portion, and wherein the child seat is fixed to the rear gate assembly such that is does not move relative to the rear gate assembly.

12. The method of claim 11, wherein the child seat further comprises a plurality of wires, wherein the plurality of wires are formed as a substantially flat wire mat, and wherein the flat wire mat is bent to form the lower seat portion and the back portion.

13. The method of claim 12, wherein the plurality of wires form a wire mesh.

14. The method of claim 12, wherein the flat wire mat is bent to form an angle between the lower seat portion and the back portion, and wherein the angle is about 93 degrees to about 105 degrees.

15. The method of claim 11, further comprising attaching a plurality of casters to the frame.

16. The method of claim 11, further comprising attaching a handle to a rear portion of the frame.

17. The method of claim 15, wherein a handle extends from the frame forming an angle relative to the back portion, and wherein the angle formed is about 5 degrees to about 15 degrees.

18. The method of claim 11, wherein the rear gate assembly pivots upwards permitting the shopping cart to nest with a second shopping cart.

19. The method of claim 11, wherein the child seat further includes a seat cover.

20. A child seat for a shopping cart comprising:
a lower seat portion; and
a back portion;
wherein a base of the lower seat portion and a base of the back portion include a rim wire and a brace loop wire, wherein the rim wire and the brace loop wire are attached to a rear gate assembly of a shopping cart, wherein the rear gate assembly of the shopping cart is configured to pivotally engage a frame of the shopping cart, and wherein the child seat does not move relative to the rear gate assembly.
